(19) United States
(12) Patent Application Publication
(10) Pub. No.: US 2011/0055573 A1
(43) Pub. Date: Mar. 3, 2011

(54) SUPPORTING FLEXIBLE USE OF SMART CARDS WITH WEB APPLICATIONS

(75) Inventors: Chee Meng Low, (US); Advait Deepak Karande, (US)

(73) Assignee: International Business Machines Corporation, Armonk, NY (US)

(21) Appl. No.: 12/553,230

(22) Filed: Sep. 3, 2009

(51) Int. Cl. H04L 9/32; G06F 15/16

(52) U.S. Cl. 713/172; 709/203; 709/202

(57) ABSTRACT

A web browser for communicating with an application at an application server, a smart card driver for accessing a smart card reader, a client agent monitoring events at the browser as a result of interaction between the browser and the application and a set of access profiles. The client agent is controlled by an access profile that defines a trigger event and an action to be performed by the client agent in response to an occurrence of the event.

### BACKGROUND OF THE INVENTION

This invention is related generally to the fields of networking and computing, and specifically to enhancing and automating the use of smart cards with the World Wide Web (WWW).

Smart cards resemble credit cards, but have a built-in programmed processor, some memory and an electronic interface to a device that can accept signals and transmit signals to a network such as the web Smart cards are useful devices that applications use for purposes of authentication, encryption of sensitive data and digital signatures. They are also used as a portable and secure carrier of users' personal data. Smart cards issued by different organizations all have different profiles, usually consisting certificates, keys, data structures, formats, and embedded applets. However, there are no well-established ways for, say, a server application to reach out to the client workstation to interact with a user's smart card. For in-house web applications, the application developer will typically need to develop a separate client component (either a full-fledged client application or some browser plug-in or applet) to act as the middleman between the user's smart card and the server-side application. Unfortunately, the collective costs of developing and maintaining such a client component for each web application, as well as the costs of deploying the respective client components to all workstations, can be rather prohibitive.

### BRIEF SUMMARY OF THE INVENTION

An embodiment of the invention comprises a web browser for communicating with an application at an application server, a smart card driver for accessing a smart card reader, a client agent monitoring events at the browser as a result of interaction between the browser and the application and a set of access profiles. The client agent is controlled by an access profile that defines a trigger event and an action to be performed by the client agent in response to an occurrence of the event.

A second embodiment is a method that automates operations between a smart card and an application executing on an application server. An access profile identifies an event and specifies an action to be performed with the smart card and with a page served by the application as a result of the event.

Events are monitored as they occur at a browser as a result of interaction between the smart card, the browser and the application. When a trigger event is observed, the action associated with the event is executed.

A third embodiment is a computer program product for automating operations between a smart card and an application executing on an application server. The computer program product comprises a computer usable medium having computer usable program code embodied therewith. The computer usable program code comprises code configured to access a profile that identifies an event and specifies an action to be performed with the smart card and with a page served by the application as a result of the event, code configured to monitor events occurring at a browser as a result of interaction between the smart card, the browser and the application, and code configured to execute the action as a result of an occurrence of the event.

The embodiments of the invention further have the capability of observing the browser visiting a web site, and loading an access profile corresponding to the web site. Further capabilities include reading and writing data from and to a smart card inserted into the smart card reader, reading and writing data from and to the application, invoking cryptographic operations on the smart card; invoking card applets installed inside the smart card. and operating controls displayed by the browser, all under control of an access profile.

### BRIEF DESCRIPTION OF THE SEVERAL VIEWS OF THE DRAWINGS

In the drawings,

FIG. 1 shows a diagram of the known prior art;

FIG. 2 shows an improvement of the prior art, including an access client, access profiles, a smart card reader and a smart card driver for automating operations between a smart card, a browser and an application;

FIG. 3 shows the general flow of operations of access agent of FIG. 2; and

FIG. 4 shows an example of automated operation of FIG. 2 using a claims application and corresponding access profiles as the example.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. In many environments, there can be computer storage or propagation media at both server and client, and software at the server that embodies the invention can be downloaded to a client for execution. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

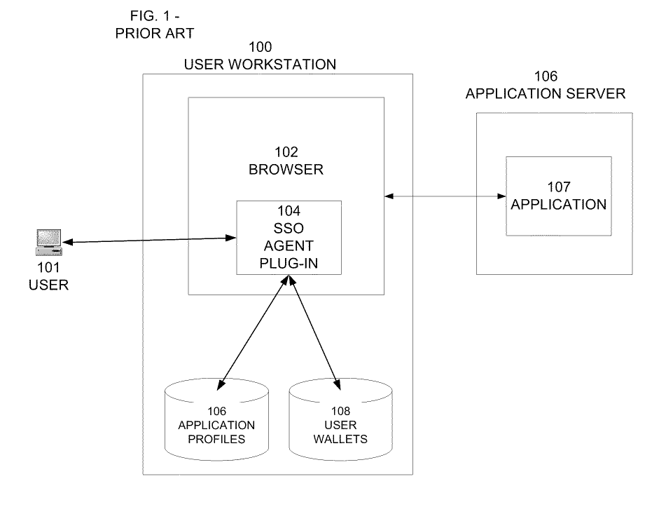

FIG. 1 shows a block diagram of the known prior art, which is a product marketed by International Business Machines Corp., named Tivoli Access Manager for Enterprise Single Sign-On (SSO). SSO can authenticate users, manage sessions and manage enterprise user single sign-on. As shown in FIG. 1, a SSO user workstation 100 contains a web browser 102. Browser 102 contains a SSO agent plug-in 104 that communicates with data stores 106 and 108 to obtain application profiles 106 and user wallets 108, respectively. Application profiles define user data that are to be pre-filled into identified form fields for an application 107 executing on application server 106. User wallets store data that is specific to a user and an application 107. Application server 106 might, for example, be a WebSphere (R) Application Server available from International Business Machines Corp. executing on a desktop computer, laptop or any general purpose computer capable of executing program/application software.

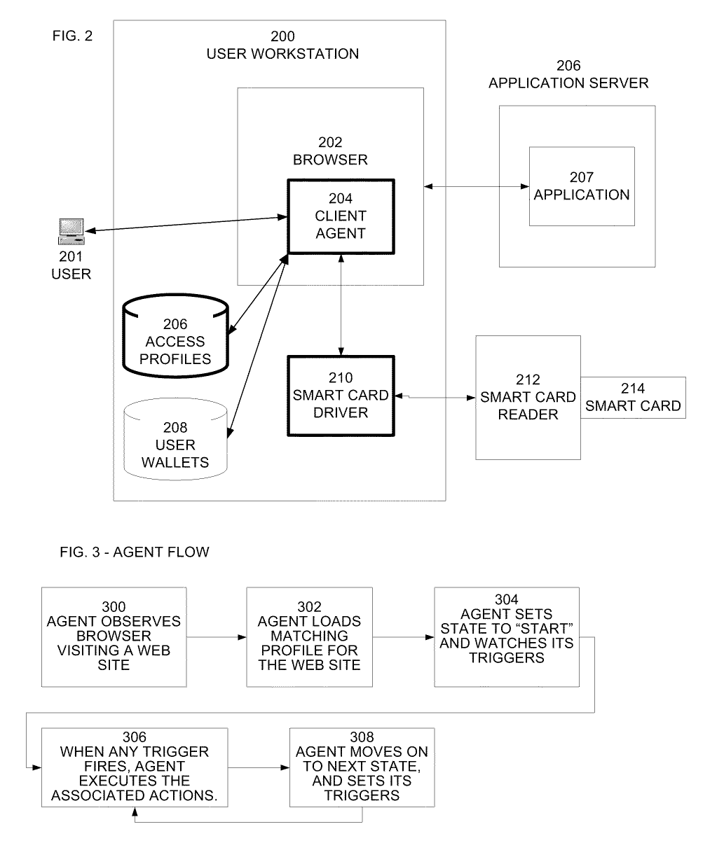

The disclosed embodiment of the invention enhances such prior art technology to allow automated operation with smart cards. As shown in FIG. 2, an embodiment of the invention replaces SSO agent plug-in 104 with what is called a client agent 204. Client agent 204 is incorporated into the browser, as a plug-in or other known methods such Java applets. Alternative embodiments of the invention could have the function written into the browser or potentially into an intercepting proxy on the client or server.

Client agent 204 has the ability to interpret and execute programs or program scripts that are described in detail below. Rather than application profiles, FIG. 2 contains access profiles, which are more sophisticated data structures that by means of commands can instruct client agent 204 to automatically perform specified operations related to web applications and web pages and forms. These profiles, which can be in the form of declarative XML, define both the triggering conditions as well as the corresponding actions (with a smart card and/or a web page or form) to be taken. Agent 204 supports a default set of built-in triggers and action operators that can be used in the Access Profiles. These defaults might include primitives such as “on_page_load”, “on_btn_click” “inject” into a web page field, “read” a file from a smart card, etc.

An access profile will typically define firstly the properties of the web application being monitored (e.g. domain/URL, SSL certification attributes, etc), and secondly, a set of (Action, Trigger) declarations that specifies the desired smartcard operation(s) upon entry/exit or upon user action on selected pages/screens of the web application. The triggers allow agent 204 to watch for certain web pages (e.g., a logon page) or user actions (e.g., submit a form), while the actions will allow agent 204 to perform tasks like reading off a string from a certain section/field of the web page, injecting a string into a certain section/field of a web page, as well as invoking various smart card operations. The agent 204 is capable of operating controls displayed on a monitor of the workstation by the browser 202. This includes controls such as buttons, hyperlinks, hot spots, etc.

For more complicated scenarios, it is possible to organize triggers and actions relevant to an application as a finite state machine. Agent 204 can also support procedural script fragments (say, written in Javascript) embedded within a profile to enable a designer to define custom actions. Such actions might execute low-level smart card operations such as APDU commands (e.g., invokea Java Card applet). The Application Protocol Data Unit (APDU) is the communication unit between a smartcard reader and a smartcard. The structure of an APDU is defined by the ISO 7816 standards.

Smart card driver 210 allows client agent 204 to interface with different varieties of smart card readers 212 and smart cards 214 without requiring re-programming of client agent 204 software. Driver 210 can alternatively be implemented as middleware. Middleware is a general term for any programming that serves to mediate between two separate software programs. Application 207 interacts with the smart card 214 under control of client agent 204 to read and write data and to perform various operations, including cryptographic operations. Client agent 204 monitors the inputs and outputs of the web browser 202 as a user 201 navigates through various pages that are served by application server 206. For example, client agent 204 is capable of reading page contents displayed by browser 202 and interacting with various elements on the web page, such as filling in text fields and clicking on a buttons and hyperlinks, all in accordance with access profiles contained within client agent 204. Communication between browser 202, application server 206 and driver 210 are implemented using standard technologies such as HTML over HTTPS and supports conventional application technologies such as Java servlets. By way of example, application server 206 can be implemented with WebSphere (R) Application Server available from International Business Machines Corp. In such an embodiment, data is transferred between smart card 214 and agent 204 in HTML text fields. Data meant for the smart card can be rendered within tagged HTML sections in the HTTPS request, while data originating from the smart card can be retrieved from designated text fields in an HTTPS response. Digital signatures are requested through HTML tags and are submitted to the server 207 within designated text fields. This embodiment allows application 207 to function without knowledge of how to interface with a smart card.

An outline of the client agent 204 workflow of the disclosed embodiment is shown in FIG. 3. At 300, agent 204 monitors the interaction between a web client and a web server and observes a browser visiting a web site. Using the URL of the web site, agent 204 at 302 loads an access profile assigned to the URL. At 304, agent 204 sets the profile state to “start” and then watches for triggers (events) that cause the agent to execute actions specified by the access profile. At 306, when a trigger “fires”, agent 204 executes the specified action or actions. At 308, agent 304 then moves on to the next state and resets its triggers according to the access profile and begins monitoring again at 306. Different access profiles can be loaded and executed along if the way if required by the profile in execution. This process continues until the executing profile terminates operation.

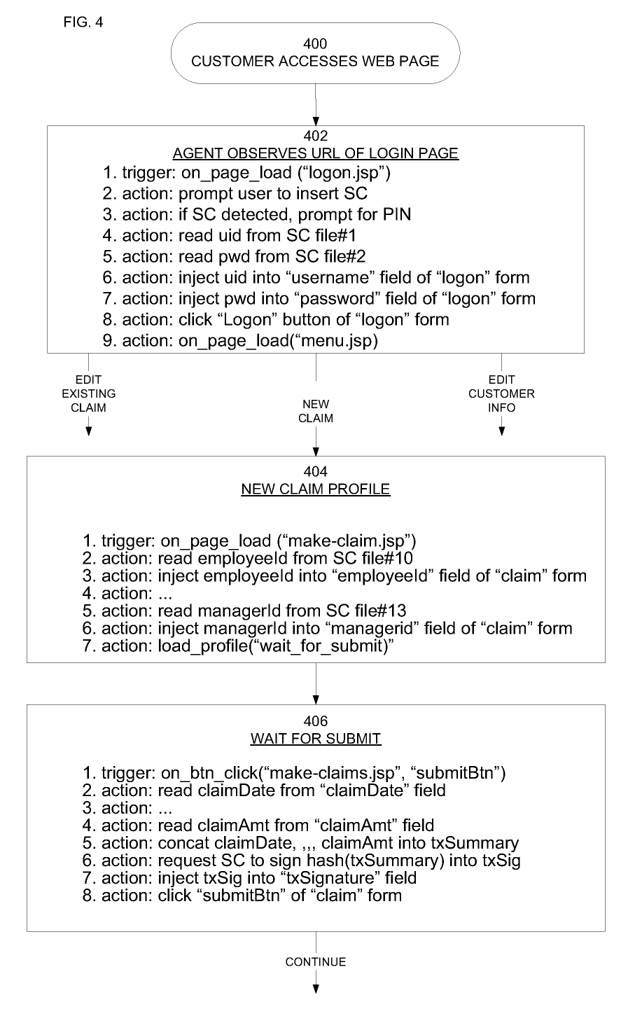

This embodiment of the invention is more clearly shown by a claims processing web application in FIG. 4 as an example. At 400, it is assumed that a user at a browser accesses the home web page of the claims processing application. The agent 304 observes the URL of a logon page and passes the URL on to the server. Agent 304 loads a logon access profile from datastore 206 using the URL of the logon page. 402 in FIG. 4 illustrates a script contained within the logon profile. Command 402-1 specifies a trigger event, which in this example is to watch for the serving of a page identified as logon.jsp. When this event occurs, action 402-2 directs agent 204 to prompt the user to insert his or her corporate smart card. When it is detected that the card is inserted into reader 212, command 402-3 prompts the user to enter a PIN that unlocks access to the smart card. When the PIN is received, and assuming that it is correct, the logon profile at commands 402-4 and 402-5 read a user ID (uid) and claims processing application password (pwd) from specified files of the smart card and at 204-6, 204-7 injects these values into the respective username and password fields of the logon page that has been displayed by the browser. Agent 204 then clicks the “Logon” button on the page at 402-8 and loads the next access profile from datastore 206 at 402-9. Let's assume that the next access profile is for a menu page that is displayed by browser 202 and that the menu page contains three options for filing a new claim, editing an existing claim or editing user information. For simplicity, the menu access profile is not shown in FIG. 4. Rather, in FIG. 4, it is assumed that the user has already selected “File New Claim”. It's also deemed unnecessary to describe the profiles for editing an existing profile or for editing user information. There can be many types of profiles that accomplish different automated operations, and the present examples are deemed sufficient to enable a skilled art worker to design and use any desired profile.

The new claim profile is shown at 404. The trigger set at 404-1 instructs agent 204 to watch for the serving of a web form identified as “make-claimjsp”. When this occurs, 404-2 reads an employeeid file from the smart card 214. 404-3 injects employeeid into the employee identification field of the claim form. Other automated operations might take place at 404-4. Commands 404-5 and 404-6 read a manager identification from smart card file managerid and injects it into the managerid field of the claim form. Finally, 404-7 directs agent 204 to load a new access profile to observe when the user clicks on a Submit button. In the meantime, the user typically will enter information known only to him or her, such as detains of the claim being submitted. Eventually, when the user clicks on the Submit button, agent 204 observes the event and begins the actions specified in the “wait_for_submit” profile. As shown in 406-2 through 406-5, these illustrative actions consist of reading a claim date and amount from the form, concatenating these values and placing the concatenated string into a smart card file txSummary. Command 406-6 requests the smart card 214 to generate a hash over the summaryTx file and place the hash into smart card 214 file txSig. 406-7 injects the contents of txSig into a claim form field “txSignature” and 406-8 then instructs agent 204 to submit the form to application 207, whereupon the necessary authentication will be performed at server 206.

The embodiments of the invention further have the capability of observing the browser visiting a web site, e.g., by monitoring the URL used by the browser, and loading an access profile corresponding to the web site. Further capabilities include reading and writing data from and to a smart card inserted into the smart card reader, reading and writing data from and to the application, invoking cryptographic operations on the smart card, invoking card applets installed inside the smart card and operating controls displayed by the browser, all under control of an access profile. Specific examples of scripts are deemed not to be necessary to enable skilled art workers to practice these capabilities in view of the examples provided in FIG. 4.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of automating operations between a smart card and an application executing on an application server, comprising:
accessing a profile that identifies an event and specifies an action to be performed with the smart card and with a page served by the application as a result of the event,
monitoring events occurring at a browser as a result of interaction between the smart card, the browser and the application, and
executing the action as a result of an occurrence of the event.

2. The method of claim 1 further comprises a client agent for observing universal resource locators (URLs) from the workstation, observing the browser visiting a web site, and loading an access profile corresponding to the web site.

3. The method of claim 1 further comprising a client agent for reading and writing data from and to a smart card inserted into the smart card reader under control of the access profile.

4. The method of claim 1 further comprising a client agent for reading and writing data from and to the application under control of the access profile.

5. The method of claim 1 further comprising a client agent for operating controls displayed at the workstation by the browser under control of the access profile.

6. The method of claim 1 further comprising invoking cryptographic operations on the smart card under control of the access profile.

7. The method of claim 1 further comprising invoking card applets installed inside the smart card under control of the access profile.

8. A user workstation comprising a web browser for communicating with an application at an application server, a smart card driver for accessing a smart card reader, a client agent monitoring events at the browser as a result of interaction between the browser and the application and a set of access profiles, wherein the client agent is controlled by an access profile that defines a trigger event and an action to be performed by the client agent in response to an occurrence of the event.

9. The workstation of claim 8 wherein the client agent comprises program code for observing universal resource locators (URLs) from the workstation, program code for observing the browser visiting a web site, and program code for loading an access profile corresponding to the web site.

10. The workstation of claim 8 wherein the client agent further comprises program code for reading and writing data from and to a smart card inserted into the smart card reader under control of the access profile.

11. The workstation of claim 8 wherein the client agent further comprises program code for reading and writing data from and to the application under control of the access profile.

12. The workstation of claim 8 wherein the client agent further comprises program code for operating controls displayed at the workstation by the browser under control of the access profile.

13. A computer program product for automating operations between a smart card and an application executing on an application server, the computer program product comprising:
a computer usable medium having computer usable program code embodied therewith, the computer usable program code comprising:
computer usable program code configured to access a profile that identifies an event and specifies an action to be performed with the smart card and with a page served by the application as a result of the event,
computer usable program code configured to monitor events occurring at a browser as a result of interaction between the smart card, the browser and the application, and
computer usable program code configured to execute the action as a result of an occurrence of the event.

14. The computer program product of claim 13 further comprises a client agent for observing universal resource locators (URLs) from the workstation, observing the browser visiting a web site, and loading an access profile corresponding to the web site.

15. The computer program product of claim 13 further comprising a client agent for reading and writing data from and to a smart card inserted into the smart card reader under control of the access profile.

16. The computer program product of claim 13 further comprising a client agent for reading and writing data from and to the application under control of the access profile.

17. The computer program product of claim 13 further comprising a client agent for operating controls displayed at the workstation by the browser under control of the access profile.

18. The computer program product of claim 13 wherein the client agent further comprises program code for invoking cryptographic operations on the smart card under control of the access profile.

19. The computer program product of claim 13 wherein the client agent further comprises program code for invoking card applets installed inside the smart card under control of the access profile.

20. The computer program product of claim 13, wherein the program code are stored in a computer readable storage medium in a data processing system, and wherein the instructions are downloaded over a network from a remote data processing system.

21. The computer program product as described in claim 13, wherein the instructions are stored in a computer readable storage medium in a server data processing system, and wherein the instructions are downloaded over a network to a remote data processing system for use in a computer readable storage medium with the remote system.
